(19) United States
(12) Patent Application Publication
(10) Pub. No.: US 2024/0274870 A1
(43) Pub. Date: Aug. 15, 2024

(54) SOLID ELECTROLYTE MATERIAL AND BATTERY USING SAME

(71) Applicant: Panasonic Intellectual Property Management Co., Ltd., Osaka (JP)

(72) Inventors: Yohei HAYASHI, Osaka (JP); Akihiro SAKAI, Nara (JP)

(21) Appl. No.: 18/609,748

(22) Filed: Mar. 19, 2024

Related U.S. Application Data
(63) Continuation of application No. PCT/JP2022/032177, filed on Aug. 26, 2022.

(30) Foreign Application Priority Data
Sep. 28, 2021 (JP) 2021-158422
Sep. 28, 2021 (JP) 2021-158425
Sep. 28, 2021 (JP) 2021-158426

(51) Int. Cl. H01M 10/0562

(52) U.S. Cl. CPC H01M 10/0562; H01M 2300/0071; H01M 2300/008

(57) ABSTRACT

A solid electrolyte material of the present disclosure is a solid electrolyte material including Li, O, and X, wherein the X is at least one selected from the group consisting of F, Cl, Br, and I, and the solid electrolyte material satisfies any one of the following (A) to (C): (A) the solid electrolyte material further includes Si and Al; (B) the solid electrolyte material further includes Mg and Al; and (C) the solid electrolyte material further includes Cr. A battery of the present disclosure includes a positive electrode, a negative electrode, and an electrolyte layer provided between the positive electrode and the negative electrode. At least one selected from the group consisting of the positive electrode, the negative electrode, and the electrolyte layer includes the solid electrolyte material of the present disclosure.

This application is a continuation of PCT/JP2022/032177 filed on Aug. 26, 2022, which claims foreign priority of Japanese Patent Applications No. 2021-158422 filed on Sep. 28, 2021, No. 2021-158425 filed on Sep. 28, 2021, and No. 2021-158426 filed on Sep. 28, 2021, the entire contents of which are incorporated herein by reference.

### BACKGROUND OF THE INVENTION

### 1. Field of the Invention

The present disclosure relates to a solid electrolyte material and a battery using the same.

### 2. Description of Related Art

JP 2011-129312 A discloses an all-solid-state battery using a sulfide solid electrolyte material.

### SUMMARY OF THE INVENTION

The present disclosure aims to provide a novel solid electrolyte material suitable for conducting lithium ions.

A solid electrolyte material of the present disclosure is a solid electrolyte material including Li, O, and X, wherein
the X is at least one selected from the group consisting of F, Cl, Br, and I, and
the solid electrolyte material satisfies any one of the following (A) to (C):
(A) the solid electrolyte material further includes Si and Al;
(B) the solid electrolyte material further includes Mg and Al; and
(C) the solid electrolyte material further includes Cr.

The present disclosure provides a novel solid electrolyte material suitable for conducting lithium ions.

### BRIEF DESCRIPTION OF THE DRAWINGS

FIG. 1 is a cross-sectional view of a battery 1000 according to Embodiment 2.

FIG. 2 is a graph showing the X-ray diffraction patterns of solid electrolyte materials according to Examples 1-1 to 1-5.

FIG. 3 is a schematic view of a pressure-molding die 300 for use in evaluating the ionic conductivity of solid electrolyte materials.

FIG. 4 is a graph showing a Cole-Cole plot obtained by impedance measurement of the solid electrolyte material according to Example 1-1.

FIG. 5 is a graph showing the initial discharge characteristics of a battery according to Example 1-1.

FIG. 6 is a graph showing the X-ray diffraction patterns of solid electrolyte materials according to Examples 2-1 to 2-4.

FIG. 7 is a graph showing a Cole-Cole plot obtained by impedance measurement of the solid electrolyte material according to Example 2-1.

FIG. 8 is a graph showing the initial discharge characteristics of a battery according to Example 2-1.

FIG. 9 is a graph showing the X-ray diffraction patterns of solid electrolyte materials according to Examples 3-1 to 3-4.

FIG. 10 is a graph showing a Cole-Cole plot obtained by impedance measurement of the solid electrolyte material according to Example 3-1.

FIG. 11 is a graph showing the initial discharge characteristics of a battery according to Example 3-1.

### DETAILED DESCRIPTION

### Outline of One Aspect According to the Present Disclosure

A solid electrolyte material according to a first aspect of the present disclosure is a solid electrolyte material including Li, O, and X, wherein
the X is at least one selected from the group consisting of F, Cl, Br, and I, and
the solid electrolyte material satisfies any one of the following (A) to (C):
(A) the solid electrolyte material further includes Si and Al;
(B) the solid electrolyte material further includes Mg and Al; and
(C) the solid electrolyte material further includes Cr.

According to the first aspect, the solid electrolyte material has a practical lithium-ion conductivity. Therefore, the solid electrolyte material according to the first aspect is a novel solid electrolyte material suitable for conducting lithium ions.

In a second aspect of the present disclosure, for example, the solid electrolyte material according to the first aspect may satisfy the (A) and may consist substantially of Li, Si, Al, O, and X.

The solid electrolyte material according to the second aspect has a high lithium-ion conductivity. The solid electrolyte material according to the second aspect can have an ionic conductivity of, for example, 1×10⁻⁴ S/cm or more.

In a third aspect of the present disclosure, for example, the solid electrolyte material according to the second aspect may be represented by the following composition formula (1):

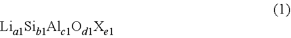

where a1>0, b1>0, c1>0, d1>0, and e1>0 may be satisfied.

The third aspect can enhance the ionic conductivity of the solid electrolyte material.

In a fourth aspect of the present disclosure, for example, in the solid electrolyte material according to the third aspect, in the composition formula (1), c1/(a1+c1)>0.4 may be satisfied.

The fourth aspect can enhance the ionic conductivity of the solid electrolyte material.

In a fifth aspect of the present disclosure, for example, in the solid electrolyte material according to the third or fourth aspect, in the composition formula (1), c1/(a1+c1)<0.95 may be satisfied.

The fifth aspect can enhance the ionic conductivity of the solid electrolyte material.

In a sixth aspect of the present disclosure, for example, in the solid electrolyte material according to any one of the third to fifth aspects, in the composition formula (1), e1/(d1+e1)>0.4 may be satisfied.

The sixth aspect can enhance the ionic conductivity of the solid electrolyte material.

In a seventh aspect of the present disclosure, for example, in the solid electrolyte material according to any one of the third to sixth aspects, in the composition formula (1), e1/(d1+e1)<0.95 may be satisfied.

The seventh aspect can enhance the ionic conductivity of the solid electrolyte material.

In an eighth aspect of the present disclosure, for example, in the solid electrolyte material according to any one of the third to seventh aspects, in the composition formula (1), b1/c1>0.05 may be satisfied.

The eighth aspect can enhance the ionic conductivity of the solid electrolyte material. Moreover, the eighth aspect achieves a stable crystal structure.

In a ninth aspect of the present disclosure, for example, in the solid electrolyte material according to any one of the third to eighth aspects, in the composition formula (1), b1/c1<1.0 may be satisfied.

The ninth aspect can enhance the ionic conductivity of the solid electrolyte material. Moreover, the ninth aspect achieves a stable crystal structure.

In a tenth aspect of the present disclosure, for example, the solid electrolyte material according to any one of the second to ninth aspects may include a 1-1st crystalline phase, wherein in an X-ray diffraction pattern of the 1-1st crystalline phase obtained by X-ray diffraction measurement using Cu-Kα radiation, at least one peak may be present within each of ranges of a diffraction angle 2θ from 14° to 16°, from 18° to 19°, from more than 19° to 20°, from 26° to 28°, from more than 28° to 30.5°, and from 47° to 50°, and at least three peaks may be present within a range of the diffraction angle 2θ from more than 30.5° to 33°.

The solid electrolyte material according to the tenth aspect has a high ionic conductivity.

In an eleventh aspect of the present disclosure, for example, the solid electrolyte material according to any one of the second to tenth aspects may include a 1-2nd crystalline phase, wherein in an X-ray diffraction pattern of the 1-2nd crystalline phase obtained by X-ray diffraction measurement using Cu-Kα radiation, at least one peak may be present within each of ranges of a diffraction angle 2θ from 11° to 14°, from 15° to 17°, from more than 23° to 26°, from more than 26° to 28.5°, and from more than 28.5° to 30°, and at least two peaks may be present within each of ranges of the diffraction angle 2θ from 20° to 23° and from 30.5° to 33°.

The solid electrolyte material according to the eleventh aspect has a high ionic conductivity.

In a twelfth aspect of the present disclosure, for example, the solid electrolyte material according to the first aspect may satisfy the (B) and may consist substantially of Li, Mg, Al, O, and X.

The solid electrolyte material according to the twelfth aspect has a high lithium-ion conductivity. The solid electrolyte material according to the second aspect can have an ionic conductivity of, for example, 4×10⁻⁷ S/cm or more.

In a thirteenth aspect of the present disclosure, for example, the solid electrolyte material according to the twelfth aspect may be represented by the following composition formula (2):

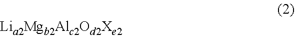

where a2>0, b2>0, c2>0, d2>0, and e2>0 may be satisfied.

The thirteenth aspect can enhance the ionic conductivity of the solid electrolyte material.

In a fourteenth aspect of the present disclosure, for example, in the solid electrolyte material according to the thirteenth aspect, in the composition formula (2), c2/(a2+c2)>0.1 may be satisfied.

The fourteenth aspect can enhance the ionic conductivity of the solid electrolyte material. Moreover, the fourteenth aspect achieves a stable crystal structure.

In a fifteenth aspect of the present disclosure, for example, in the solid electrolyte material according to the thirteenth or fourteenth aspect, in the composition formula (2), c2/(a2+c2)<0.95 may be satisfied.

The fifteenth aspect can enhance the ionic conductivity of the solid electrolyte material.

In a sixteenth aspect of the present disclosure, for example, in the solid electrolyte material according to any one of the thirteenth to fifteenth aspects, in the composition formula (2), e2/(d2+e2)>0.4 may be satisfied.

The sixteenth aspect can enhance the ionic conductivity of the solid electrolyte material.

In a seventeenth aspect of the present disclosure, for example, in the solid electrolyte material according to any one of the thirteenth to sixteenth aspects, in the composition formula (2), e2/(d2+e2)<0.95 may be satisfied.

The seventeenth aspect can enhance the ionic conductivity of the solid electrolyte material. Moreover, the seventeenth aspect achieves a stable crystal structure.

In an eighteenth aspect of the present disclosure, for example, in the solid electrolyte material according to any one of the thirteenth to seventeenth aspects, in the composition formula (2), b2/c2>0.05 may be satisfied.

The eighteenth aspect can enhance the ionic conductivity of the solid electrolyte material. Moreover, the eighteenth aspect achieves a stable crystal structure.

In a nineteenth aspect of the present disclosure, for example, in the solid electrolyte material according to any one of the thirteenth to eighteenth aspects, in the composition formula (2), b2/c2<2 may be satisfied.

The nineteenth aspect can enhance the ionic conductivity of the solid electrolyte material. Moreover, the nineteenth aspect achieves a stable crystal structure.

In a twentieth aspect of the present disclosure, for example, the solid electrolyte material according to any one of the twelfth to nineteenth aspects may include a 2-1st crystalline phase, wherein in an X-ray diffraction pattern of the 2-1st crystalline phase obtained by X-ray diffraction measurement using Cu-Kα radiation, at least one peak may be present within each of ranges of a diffraction angle 2θ from 28° to 32°, from 33° to 37°, and from 48° to 52°.

The solid electrolyte material according to the twentieth aspect has a high ionic conductivity.

In a twenty-first aspect of the present disclosure, for example, the solid electrolyte material according to the first aspect may satisfy the (C).

The solid electrolyte material according to the twenty-first aspect has a high lithium-ion conductivity. The solid electrolyte material according to the twenty-first aspect can have an ionic conductivity of, for example, 1×10⁻⁶ S/cm or more.

In a twenty-second aspect of the present disclosure, for example, the solid electrolyte material according to the twenty-first aspect may further include Al.

The solid electrolyte material according to the twenty-second aspect has a high lithium-ion conductivity.

In a twenty-third aspect of the present disclosure, for example, the solid electrolyte material according to the twenty-first or twenty-second aspect may be represented by the following composition formula (3):

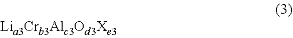

where a3>0, b3>0, c3≥0, d3>0, and e3>0 may be satisfied.

The twenty-third aspect can enhance the ionic conductivity of the solid electrolyte material.

In a twenty-fourth aspect of the present disclosure, for example, in the solid electrolyte material according to the twenty-third aspect, in the composition formula (3), b3/(a3+b3)>0.025 may be satisfied.

The twenty-fourth aspect can enhance the ionic conductivity of the solid electrolyte material. Moreover, the twenty-fourth aspect achieves a stable crystal structure.

In a twenty-fifth aspect of the present disclosure, for example, in the solid electrolyte material according to the twenty-third or twenty-fourth aspect, in the composition formula (3), b3/(a3+b3)<0.95 may be satisfied.

The twenty-fifth aspect can enhance the ionic conductivity of the solid electrolyte material.

In a twenty-sixth aspect of the present disclosure, for example, in the solid electrolyte material according to any one of the twenty-third to twenty-fifth aspects, in the composition formula (3), e3/(d3+e3)>0.4 may be satisfied.

The twenty-sixth aspect can enhance the ionic conductivity of the solid electrolyte material.

In a twenty-seventh aspect of the present disclosure, for example, in the solid electrolyte material according to any one of the twenty-third to twenty-sixth aspects, in the composition formula (3), e3/(d3+e3)<0.95 may be satisfied.

The twenty-seventh aspect can enhance the ionic conductivity of the solid electrolyte material. Moreover, the twenty-seventh aspect achieves a stable crystal structure.

In a twenty-eighth aspect of the present disclosure, for example, in the solid electrolyte material according to any one of the twenty-first to twenty-seventh aspects, in the composition formula (3), 0≤c3/b3≤20 may be satisfied.

The twenty-eighth aspect can enhance the ionic conductivity of the solid electrolyte material. Moreover, the twenty-eighth aspect achieves a stable crystal structure.

In a twenty-ninth aspect of the present disclosure, for example, the solid electrolyte material according to any one of the twenty-first to twenty-eighth aspects may include a 3-1 st crystalline phase, wherein in an X-ray diffraction pattern of the 3-1st crystalline phase obtained by X-ray diffraction measurement using Cu-Kα radiation, at least one peak may be present within each of ranges of a diffraction angle 2θ from 28° to 32°, from 33° to 37°, and from 48° to 52°.

The solid electrolyte material according to the twenty-ninth aspect has a high ionic conductivity.

In a thirtieth aspect of the present disclosure, for example, the solid electrolyte material according to any one of the twenty-first to twenty-ninth aspects may include a 3-2nd crystalline phase, wherein in an X-ray diffraction pattern of the 3-2nd crystalline phase obtained by X-ray diffraction measurement using Cu-Kα radiation, at least one peak may be present within each of ranges of a diffraction angle 2θ from 23° to 27°, from 32° to 35°, from more than 35° to 38°, from 40° to 44°, and from 53° to 57°.

The solid electrolyte material according to the thirtieth aspect has a high ionic conductivity.

In a thirty-first aspect of the present disclosure, for example, in the solid electrolyte material according to any one of the first to thirtieth aspects, the X may include Cl.

The thirty-first aspect can enhance the ionic conductivity of the solid electrolyte material.

A battery according to a thirty-second aspect of the present disclosure includes:
a positive electrode;
a negative electrode; and
an electrolyte layer disposed between the positive electrode and the negative electrode, wherein
at least one selected from the group consisting of the positive electrode, the negative electrode, and the electrolyte layer includes the solid electrolyte material according to any one of the first to thirty-first aspects.

The battery according to the thirty-second aspect has excellent charge and discharge characteristics.

Embodiments of the present disclosure will be described below with reference to the drawings.

### Embodiment 1

A solid electrolyte material according to Embodiment 1 is a solid electrolyte material including Li, O, and X, wherein
the X is at least one selected from the group consisting of F, Cl, Br, and I, and
the solid electrolyte material satisfies any one of the following (A) to (C):
(A) the solid electrolyte material further includes Si and Al;
(B) the solid electrolyte material further includes Mg and Al; and
(C) the solid electrolyte material further includes Cr.

The solid electrolyte material according to Embodiment 1 is a novel solid electrolyte material suitable for conducting lithium ions. The solid electrolyte material according to Embodiment 1 can have, for example, a practical lithium-ion conductivity, and has, for example, a high lithium-ion conductivity. A high lithium-ion conductivity is, for example, 4×10⁻⁷ S/cm or more at near room temperature. Room temperature is, for example, 25° C.

The solid electrolyte material according to Embodiment 1 can be used in order to obtain a battery having excellent charge and discharge characteristics. An example of the battery is an all-solid-state battery. The all-solid-state battery may be a primary battery or a secondary battery.

In the case where the solid electrolyte material according to Embodiment 1 satisfies the above (A), the solid electrolyte material according to Embodiment 1 may consist substantially of Li, Si, Al, O, and X.

According to the above configuration, the solid electrolyte material according to Embodiment 1 can have an ionic conductivity of, for example, 1×10⁻⁴ S/cm or more.

In the present disclosure, the phrase “the solid electrolyte material according to Embodiment 1 consists substantially of Li, Si, Al, O, and X” means that the ratio (i.e., mole fraction) of the sum of the amounts of substance of Li, Si, Al, O, and X to the total of the amounts of substance of all the elements constituting the solid electrolyte material according to Embodiment 1 is 95% or more. In an example, the ratio may be 98% or more.

To enhance the ionic conductivity of the solid electrolyte material, the solid electrolyte material according to Embodiment 1 may consist of Li, Si, Al, O, and X.

Desirably, in the case where the solid electrolyte material according to Embodiment 1 satisfies the above (A), the solid electrolyte material according to Embodiment 1 is free of sulfur. The solid electrolyte material free of sulfur generates no hydrogen sulfide when exposed to the atmosphere, and is accordingly excellent in safety. The sulfide solid electrolyte disclosed in JP 2011-129312 A can generate hydrogen sulfide when exposed to the atmosphere.

The solid electrolyte material according to Embodiment 1 may contain an element unavoidably incorporated. Examples of the element include hydrogen and nitrogen. Such an element can be present in the raw material powder of the solid electrolyte material or in an atmosphere for manufacturing or storing the solid electrolyte material. The element unavoidably incorporated into the solid electrolyte material according to Embodiment 1 has an amount of, for example, 1 mol % or less.

To enhance the ionic conductivity of the solid electrolyte material, the solid electrolyte material according to Embodiment 1 may be a material represented by the following composition formula (1):

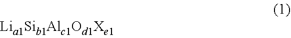

where a1>0, b1>0, c1>0, d1>0, and e1>0 are satisfied.

To enhance the ionic conductivity of the solid electrolyte material, in Formula (1), when c1=1, 0<a1≤3 may be satisfied, 0.05≤a1≤1.5 may be satisfied, and 0.216≤a1≤0.556 may be satisfied.

To enhance the ionic conductivity of the solid electrolyte material, in Formula (1), when c1=1, 0<b1≤2 may be satisfied, 0.05≤b1≤1 may be satisfied, and 0.0526≤b1≤0.25 may be satisfied.

To enhance the ionic conductivity of the solid electrolyte material, in Formula (1), when c1=1, 0<d1≤3 may be satisfied, 0.14<d1≤1.7 may be satisfied, and 1.11≤d1≤1.31 may be satisfied.

To enhance the ionic conductivity of the solid electrolyte material, in Formula (1), when c1=1, 0<e1≤6 may be satisfied, 0.76<e1≤4.1 may be satisfied, and 1.17≤e1≤2 may be satisfied.

To enhance the ionic conductivity of the solid electrolyte material, in Formula (1), c1/(a1+c1)>0.4 may be satisfied. In this case, the amount of lithium contained in the crystals is not excessive, thereby facilitating formation of a solid solution of lithium in the crystals. That is, a stable crystal structure is achieved.

To enhance the ionic conductivity of the solid electrolyte material, in Formula (1), c1/(a1+c1)<0.95 may be satisfied. In this case, a sufficient amount of lithium ions are present in the crystals, thereby facilitating conduction of lithium ions.

The upper and lower limits for c1/(a1+c1) in Formula (1) can be defined by any combination of numerical values selected from more than 0.4, 0.438, 0.643, 0.667, 0.77, 0.794, 0.823, 0.906, and less than 0.95.

To enhance the ionic conductivity of the solid electrolyte material, in Formula (1), 0.4<c1/(a1+c1)<0.95 may be satisfied, 0.438≤c1/(a1+c1)≤0.906 may be satisfied, and 0.643≤c1/(a1+c1)≤0.823 may be satisfied.

To enhance the ionic conductivity of the solid electrolyte material, in Formula (1), e1/(d1+e1)>0.4 may be satisfied. In this case, the amount of oxygen contained in the crystals is not excessive, and thereby oxygen, which is a divalent anion, can be prevented from hindering lithium-ion conduction.

To enhance the ionic conductivity of the solid electrolyte material, in Formula (1), e1/(d1+e1)<0.95 may be satisfied. In this case, a sufficient amount of oxygen is present in the crystals, and thereby high binding properties of oxygen can achieve a stable crystal structure.

The upper and lower limits for e1/(d1+e1) in Formula (1) can be defined by any combination of numerical values selected from more than 0.4, 0.45, 0.5, 0.615, 0.833, and less than 0.95.

To enhance the ionic conductivity of the solid electrolyte material, in Formula (1), 0.4<e1/(d1+e1)<0.95 may be satisfied, 0.45≤e1/(d1+e1)≤0.833 may be satisfied, and 0.50≤e1/(d1+e1)≤0.615 may be satisfied.

To enhance the ionic conductivity of the solid electrolyte material, in Formula (1), b1/c1>0.05 may be satisfied. In this case, the crystalline phase can be stably present in the crystals. That is, a stable crystal structure is achieved.

To enhance the ionic conductivity of the solid electrolyte material, in Formula (1), b1/c1<1.0 may be satisfied. In this case, the crystalline phase can be stably present in the crystals. That is, a stable crystal structure is achieved.

The upper and lower limits for b1/c1 in Formula (1) can be defined by any combination of numerical values selected from more than 0.05, 0.0526, 0.111, 0.176, 0.25, 0.8, and less than 1.

To enhance the ionic conductivity of the solid electrolyte material, in Formula (1), 0.05<b1/c1<1.0 may be satisfied, 0.05<b1/c1≤0.8 may be satisfied, and 0.0526≤b1/c1≤0.25 may be satisfied.

The X-ray diffraction pattern of the solid electrolyte material according to Embodiment 1 can be measured by the θ-2θ method using Cu-Kα radiation (wavelengths of 1.5405 Å and 1.5444 Å) as the X-ray source.

In the case where the solid electrolyte material according to Embodiment 1 satisfies the above (A), the solid electrolyte material according to Embodiment 1 may include a 1-1st crystalline phase. In the X-ray diffraction pattern of the 1-1st crystalline phase, at least one peak is present within each of ranges of a diffraction angle 2θ from 14° to 16°, from 18° to 19°, from more than 19° to 20°, from 26° to 28°, from more than 28° to 30.5°, and from 47° to 50°, and at least three peaks are present within a range of the diffraction angle 2θ from more than 30.5° to 33°. Solid electrolyte materials including the 1-1 st crystalline phase have a high ionic conductivity.

The angle of a peak is an angle at which the maximum intensity is exhibited for a projecting portion having an SN ratio of 3 or more and a half width of 10° or less. The half width is a width represented by the difference between two diffraction angles at which the intensity is half of IMAX, where IMAX is the maximum intensity of the peak. The SN ratio is the ratio of a signal S to a background noise N.

In the case where the solid electrolyte material according to Embodiment 1 satisfies the above (A), the solid electrolyte material according to Embodiment 1 may include a 1-2nd crystalline phase. In the X-ray diffraction pattern of the 1-2nd crystalline phase, at least one peak is present within each of ranges of the diffraction angle 2θ from 11° to 14°, from 15° to 17°, from more than 23° to 26°, from more than 26° to 28.5°, and from more than 28.5° to 30°, and at least two peaks are present within each of ranges of the diffraction angle 2θ from 20° to 23° and from 30.5° to 33°. Solid electrolyte materials including the 1-2nd crystalline phase have a high ionic conductivity.

To enhance the ionic conductivity of the solid electrolyte material, the solid electrolyte material according to Embodiment 1 may include both the 1-1st crystalline phase and the 1-2nd crystalline phase.

In the case where the solid electrolyte material according to Embodiment 1 satisfies the above (A), the solid electrolyte material according to Embodiment 1 may further include a 1-3rd crystalline phase having a crystal structure different from the crystal structures of the 1-1st crystalline phase and the 1-2nd crystalline phase.

In the case where the solid electrolyte material according to Embodiment 1 satisfies the above (B), the solid electrolyte material according to Embodiment 1 may consist substantially of Li, Mg, Al, O, and X.

According to the above configuration, the solid electrolyte material according to Embodiment 1 can have an ionic conductivity of, for example, 4×10⁻⁷ S/cm or more at near room temperature.

In the present disclosure, the phrase “the solid electrolyte material according to Embodiment 1 consists substantially of Li, Mg, Al, O, and X” means that the ratio (i.e., mole fraction) of the sum of the amounts of substance of Li, Mg, Al, O, and X to the total of the amounts of substance of all the elements constituting the solid electrolyte material according to Embodiment 1 is 95% or more. In an example, the ratio may be 98% or more.

To enhance the ionic conductivity of the solid electrolyte material, the solid electrolyte material according to Embodiment 1 may consist of Li, Mg, Al, O, and X.

Desirably, in the case where the solid electrolyte material according to Embodiment 1 satisfies the above (B), the solid electrolyte material according to Embodiment 1 is free of sulfur. The solid electrolyte material free of sulfur generates no hydrogen sulfide when exposed to the atmosphere, and is accordingly excellent in safety. The sulfide solid electrolyte disclosed in JP 2011-129312 A can generate hydrogen sulfide when exposed to the atmosphere.

To enhance the ionic conductivity of the solid electrolyte material, the solid electrolyte material according to Embodiment 1 may be a material represented by the following composition formula (2):

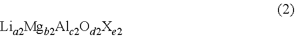

where a2>0, b2>0, c2>0, d2>0, and e2>0 are satisfied.

To enhance the ionic conductivity of the solid electrolyte material, in Formula (2), when c2=1, 0<a2≤5.5 may be satisfied, 0.05≤a2≤5 may be satisfied, and 0.481≤a2≤4.71 may be satisfied.

To enhance the ionic conductivity of the solid electrolyte material, in Formula (2), when c2=1, 0<b2≤1 may be satisfied, 0.05≤b2≤1 may be satisfied, and 0.11≤b2≤0.429 may be satisfied.

To enhance the ionic conductivity of the solid electrolyte material, in Formula (2), when c2=1, 0<d2≤3 may be satisfied, 0.14<d2≤1.7 may be satisfied, and 1.11≤d2≤1.43 may be satisfied.

To enhance the ionic conductivity of the solid electrolyte material, in Formula (2), when c2=1, 0<e2≤6 may be satisfied, 0.76<e2≤5.8 may be satisfied, and 1.23≤e2≤5.71 may be satisfied.

To enhance the ionic conductivity of the solid electrolyte material, in Formula (2), c2/(a2+c2)>0.1 may be satisfied. In this case, the amount of lithium contained in the crystals is not excessive, thereby facilitating formation of a solid solution of lithium in the crystals. That is, a stable crystal structure is achieved.

To enhance the ionic conductivity of the solid electrolyte material, in Formula (2), c2/(a2+c2)<0.95 may be satisfied. In this case, a sufficient amount of lithium ions are present in the crystals, thereby facilitating conduction of lithium ions.

The upper and lower limits for c2/(a2+c2) in Formula (2) can be defined by any combination of numerical values selected from more than 0.1, 0.175, 0.225, 0.6, 0.675, and less than 0.95.

To enhance the ionic conductivity of the solid electrolyte material, in Formula (2), 0.1<c2/(a2+c2)<0.95 may be satisfied, 0.15≤c2/(a2+c2)≤0.906 may be satisfied, and 0.175≤c2/(a2+c2)≤0.675 may be satisfied.

To enhance the ionic conductivity of the solid electrolyte material, in Formula (2), b2/c2>0.05 may be satisfied. In this case, the crystalline phase can be stably present in the crystals. That is, a stable crystal structure is achieved.

To enhance the ionic conductivity of the solid electrolyte material, in Formula (2), b2/c2<2 may be satisfied. In this case, the crystalline phase can be stably present in the crystals. That is, a stable crystal structure is achieved.

The upper and lower limits for b2/c2 in Formula (2) can be defined by any combination of numerical values selected from more than 0.05, 0.111, 0.250, 0.429, 0.8, 1, and less than 2.

To enhance the ionic conductivity of the solid electrolyte material, in Formula (2), 0.05<b2/c2<2 may be satisfied, 0.1<b2/c2<1 may be satisfied, and 0.111≤b2/c2≤0.429 may be satisfied.

To enhance the ionic conductivity of the solid electrolyte material, in Formula (2), e2/(d2+e2)>0.4 may be satisfied. In this case, the amount of oxygen contained in the crystals is not excessive, and thereby oxygen, which is a divalent anion, can be prevented from hindering lithium-ion conduction.

To enhance the ionic conductivity of the solid electrolyte material, in Formula (2), e2/(d2+e2)<0.95 may be satisfied. In this case, a sufficient amount of oxygen is present in the crystals, and thereby high binding properties of oxygen can achieve a stable crystal structure.

The upper and lower limits for e2/(d2+e2) in Formula (1) can be defined by any combination of numerical values selected from more than 0.4, 0.45, 0.5, 0.8, 0.833, and less than 0.95.

To enhance the ionic conductivity of the solid electrolyte material, in Formula (2), 0.4<e2/(d2+e2)<0.95 may be satisfied, 0.45≤e2/(d2+e2)≤0.833 may be satisfied, and 0.50≤e2/(d2+e2)≤0.80 may be satisfied.

In the case where the solid electrolyte material according to Embodiment 1 satisfies the above (B), the solid electrolyte material according to Embodiment 1 may include a 2-1st crystalline phase. In the X-ray diffraction pattern of the 2-1st crystalline phase, at least one peak is present within each of ranges of the diffraction angle 2θ from 28° to 32°, from 33° to 37°, and from 48° to 52°. Solid electrolyte materials including the 2-1 st crystalline phase have a high ionic conductivity.

In the case where the solid electrolyte material according to Embodiment 1 satisfies the above (B), the solid electrolyte material according to Embodiment 1 may further include a 2-2nd crystalline phase having a crystal structure different from the crystal structure of the 2-1st crystalline phase.

The solid electrolyte material according to Embodiment 1 may satisfy the above (C).

According to the above configuration, the solid electrolyte material according to Embodiment 1 can have an ionic conductivity of, for example, 1×10⁻⁶ S/cm or more at near room temperature.

Desirably, in the case where the solid electrolyte material according to Embodiment 1 satisfies the above (C), the solid electrolyte material according to Embodiment 1 is substantially free of sulfur. The phrase “the solid electrolyte material according to Embodiment 1 is substantially free of sulfur” means that the solid electrolyte material does not contain sulfur as its constituent element, except for sulfur unavoidably incorporated as impurities. In this case, sulfur incorporated as impurities into the solid electrolyte material has an amount of, for example, 1 mol % or less. From the viewpoint of safety, the solid electrolyte material according to Embodiment 1 is desirably free of sulfur. The solid electrolyte material free of sulfur generates no hydrogen sulfide when exposed to the atmosphere, and is accordingly excellent in safety. The sulfide solid electrolyte disclosed in JP 2011-129312 A can generate hydrogen sulfide when exposed to the atmosphere.

The solid electrolyte material according to Embodiment 1 may consist substantially of Li, Cr, O, and X. The phrase “the solid electrolyte material according to Embodiment 1 consists substantially of Li, Cr, O, and X” means that the ratio (i.e., mole fraction) of the sum of the amounts of substance of Li, Cr, O, and X to the total of the amounts of substance of all the elements constituting the solid electrolyte material according to Embodiment 1 is 95% or more. In an example, the ratio may be 98% or more.

To enhance the ionic conductivity of the solid electrolyte material, the solid electrolyte material according to Embodiment 1 may consist of Li, Cr, O, and X.

In the case where the solid electrolyte material according to Embodiment 1 satisfies the above (C), the solid electrolyte material according to Embodiment 1 may further include Al.

The solid electrolyte material according to Embodiment 1 may consist substantially of Li, Cr, Al, O, and X. The phrase “the solid electrolyte material according to Embodiment 1 consists substantially of Li, Cr, Al, O, and X” means that the molar ratio (i.e., mole fraction) of the sum of the amounts of substance of Li, Cr, Al, O, and X to the total of the amounts of substance of all the elements constituting the solid electrolyte material according to Embodiment 1 is 95% or more. In an example, the molar ratio may be 98% or more.

To enhance the ionic conductivity of the solid electrolyte material, the solid electrolyte material according to Embodiment 1 may consist of Li, Cr, Al, O, and X.

To enhance the ionic conductivity of the solid electrolyte material, the solid electrolyte material according to Embodiment 1 may be a material represented by the following composition formula (3):

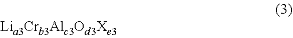

where a3>0, b3>0, c3≥0, d3>0, and e3>0 are satisfied.

To enhance the ionic conductivity of the solid electrolyte material, in Formula (3), when b3=1, 0<a3≤30 may be satisfied, 0.05≤a3≤30 may be satisfied, and 2.0≤a3≤30 may be satisfied.

To enhance the ionic conductivity of the solid electrolyte material, in Formula (3), when b3=1, 0≤c3≤20 may be satisfied, 0≤c3≤9.0 may be satisfied, and 4.0≤c3≤9.0 may be satisfied.

To enhance the ionic conductivity of the solid electrolyte material, in Formula (3), when b3=1, 0<d3≤10 may be satisfied and 1.0≤d3≤10 may be satisfied.

To enhance the ionic conductivity of the solid electrolyte material, in Formula (3), when b3=1, 0<e3 $40 may be satisfied and 3<e3≤40 may be satisfied.

To enhance the ionic conductivity of the solid electrolyte material, in Formula (3), b3/(a3+b3)>0.025 may be satisfied. In this case, the amount of lithium contained in the crystals is not excessive, thereby facilitating formation of a solid solution of lithium in the crystals. That is, a stable crystal structure is achieved.

To enhance the ionic conductivity of the solid electrolyte material, in Formula (3), b3/(a3+b3)<0.95 may be satisfied. In this case, a sufficient amount of lithium ions are present in the crystals, thereby facilitating conduction of lithium ions.

The upper and lower limits for b3/(a3+b3) in Formula (3) can be defined by any combination of numerical values selected from more than 0.025, 0.0323, 0.0625, 0.25, 0.333, and less than 0.95.

To enhance the ionic conductivity of the solid electrolyte material, in Formula (3), 0.025<b3/(a3+b3)<0.95 may be satisfied and 0.0323≤c3/(a3+c3)≤0.333 may be satisfied.

To enhance the ionic conductivity of the solid electrolyte material, in Formula (3), e3/(d3+e3)>0.4 may be satisfied. In this case, the amount of oxygen contained in the crystals is not excessive, and thereby oxygen, which is a divalent anion, can be prevented from hindering lithium-ion conduction.

To enhance the ionic conductivity of the solid electrolyte material, in Formula (3), e3/(d3+e3)<0.95 may be satisfied. In this case, a sufficient amount of oxygen is present in the crystals, and thereby high binding properties of oxygen can achieve a stable crystal structure.

The upper and lower limits for e3/(d3+e3) in Formula (3) can be defined by any combination of numerical values selected from more than 0.4, 0.45, 0.75, 0.8, 0.833, and less than 0.95.

To enhance the ionic conductivity of the solid electrolyte material, in Formula (3), 0.4<e3/(d3+e3)<0.95 may be satisfied, 0.45≤e3/(d3+e3)≤0.833 may be satisfied, and 0.75≤e3/(d3+e3)≤0.80 may be satisfied.

To enhance the ionic conductivity of the solid electrolyte material, in Formula (3), 0≤c3/b3≤20 may be satisfied. In this case, the crystalline phase can be stably present in the crystals. That is, a stable crystal structure is achieved.

To enhance the ionic conductivity of the solid electrolyte material, in Formula (3), 0≤c3/b3≤20 may be satisfied, 0≤c3/b3≤15 may be satisfied, and 0≤c3/b3≤9 may be satisfied.

In the case where the solid electrolyte material according to Embodiment 1 satisfies the above (C), the solid electrolyte material according to Embodiment 1 may include a 3-1st crystalline phase. In the X-ray diffraction pattern of the 3-1st crystalline phase, at least one peak is present within each of ranges of the diffraction angle 2θ from 28° to 32°, from 33° to 37°, and from 48° to 52°. Solid electrolyte materials including the 3-1 st crystalline phase have a high ionic conductivity.

In the case where the solid electrolyte material according to Embodiment 1 satisfies the above (C), the solid electrolyte material according to Embodiment 1 may include a 3-2nd crystalline phase. In the X-ray diffraction pattern of the 3-2nd crystalline phase, at least one peak is present within each of ranges of the diffraction angle 2θ from 23° to 27°, from 32° to 35°, from more than 35° to 38°, from 40° to 44°, and from 53° to 57°. Solid electrolyte materials including the 3-2nd crystalline phase have a high ionic conductivity.

To enhance the ionic conductivity of the solid electrolyte material, in the case where the solid electrolyte material according to Embodiment 1 satisfies the above (C), the solid electrolyte material according to Embodiment 1 may include both the 3-1st crystalline phase and the 3-2nd crystalline phase.

In the case where the solid electrolyte material according to Embodiment 1 satisfies the above (C), the solid electrolyte material according to Embodiment 1 may further include a 3-3rd crystalline phase having a crystal structure different from the crystal structures of the 3-1st crystalline phase and the 3-2nd crystalline phase.

To enhance the ionic conductivity of the solid electrolyte material, in the solid electrolyte material according to Embodiment 1, X may include Cl. X may be Cl.

The shape of the solid electrolyte material according to Embodiment 1 is not limited. Examples of the shape include an acicular shape, a spherical shape, and an ellipsoidal shape. The solid electrolyte material according to Embodiment 1 may be particulate. The solid electrolyte material according to Embodiment 1 may be in the shape of a pellet or a plate.

In the case where the solid electrolyte material according to Embodiment 1 is particulate (e.g., spherical), the solid electrolyte material may have a median diameter of 0.1 μm or more and 100 μm or less, and may have a median diameter of 0.5 μm or more and 10 μm or less. In this case, the solid electrolyte material according to Embodiment 1 has a higher ionic conductivity. Furthermore, in the case where the solid electrolyte material according to Embodiment 1 is mixed with a different material such as an active material, a favorable dispersion state of the solid electrolyte material according to Embodiment 1 and the different material is achieved.

The median diameter means the particle diameter (d50) at a cumulative volume equal to 50% in the volumetric particle size distribution. The volumetric particle size distribution is measured with, for example, a laser diffraction analyzer or an image analyzer.

### <Method for Manufacturing Solid Electrolyte Material>

The solid electrolyte material according to Embodiment 1 is manufactured by, for example, the following method.

Raw material powders are prepared and mixed so as to obtain a target composition. The raw material powders may be, for example, a halide and an oxide.

In an example, in the case where the target composition is Li_{0.298}Si_{0.0526}AlO_{1.17}Cl_{1.17}, a LiCl raw material powder, an AlCl₃ raw material powder, an Al₂O₃ raw material powder, and a SiO₂ raw material powder are mixed at a molar ratio of LiCl:AlCl₃:Al₂O₃:SiO₂=0.299:0.292:0.356:0.0528. The raw material powders may be mixed at a molar ratio adjusted in advance so as to cancel out a composition change that may occur in the synthesis process.

In an example, in the case where the target composition is Li₃Mg_{0.1}Al_{0.90}Cl₄, a LiCl raw material powder, a Li₂O raw material powder, a MgCl₂ raw material powder, and an AlCl₃ raw material powder are mixed at a molar ratio of LiCl:Li₂O:MgCl₂:AlCl₃=0.333:0.333:0.0333:0.300. The raw material powders may be mixed at a molar ratio adjusted in advance so as to cancel out a composition change that may occur in the synthesis process.

In an example, in the case where the target composition is Li₃CrOCl₄, a LiCl raw material powder, a Li₂O raw material powder, and a CrCl₃ raw material powder are mixed at a molar ratio of LiCl:Li₂O:CrCl3=0.333:0.333:0.333. The raw material powders may be mixed at a molar ratio adjusted in advance so as to cancel out a composition change that may occur in the synthesis process.

The raw material powders mixed are reacted with each other mechanochemically in a mixer, such as a planetary ball mill, to obtain a reactant. That is, the raw material powders are reacted with each other by mechanochemical milling. The resultant reactant may be further fired in an inert gas atmosphere or in a vacuum.

Alternatively, the mixture of the raw material powders may be fired in an inert gas atmosphere or in a vacuum to react with each other thus to obtain a reactant. Examples of the inert gas include helium, nitrogen, and argon.

By these methods, the solid electrolyte material according to Embodiment 1 is obtained.

The composition of the solid electrolyte material can be determined by, for example, high-frequency inductively coupled plasma (ICP) emission spectrometry and ion chromatography. For example, the composition of Li can be determined by ICP emission spectrometry, and the composition of Si, Mg, Cr, Al, O, and X can be determined by ion chromatography.

### Embodiment 2

Embodiment 2 will be described below. The matters described in Embodiment 1 can be omitted as appropriate.

A battery according to Embodiment 2 includes a positive electrode, an electrolyte layer, and a negative electrode. The electrolyte layer is disposed between the positive electrode and the negative electrode. At least one selected from the group consisting of the positive electrode, the electrolyte layer, and the negative electrode includes the solid electrolyte material according to Embodiment 1.

The battery according to Embodiment 2 includes the solid electrolyte material according to Embodiment 1, and accordingly has excellent charge and discharge characteristics.

A specific example of the battery according to Embodiment 2 will be described below.

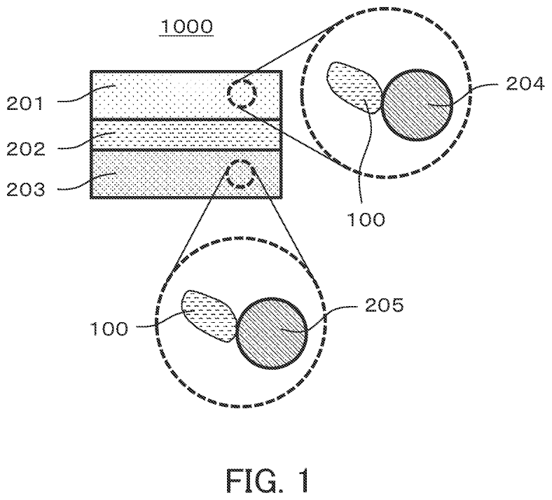

FIG. 1 is a cross-sectional view of a battery 1000 according to Embodiment 2.

The battery 1000 includes a positive electrode 201, an electrolyte layer 202, and a negative electrode 203. The electrolyte layer 202 is disposed between the positive electrode 201 and the negative electrode 203.

The positive electrode 201 includes a positive electrode active material 204 and a solid electrolyte 100.

The negative electrode 203 includes a negative electrode active material 205 and the solid electrolyte 100.

The solid electrolyte 100 includes, for example, the solid electrolyte material according to Embodiment 1. The solid electrolyte 100 is, for example, in the form of particles including the solid electrolyte material according to Embodiment 1 as the main component. The particles including the solid electrolyte material according to Embodiment 1 as the main component mean particles in which the component contained in the largest amount in molar ratio is the solid electrolyte material according to Embodiment 1. The solid electrolyte 100 may be in the form of particles consisting of the solid electrolyte material according to Embodiment 1.

The positive electrode 201 includes a material capable of occluding and releasing metal ions (e.g., lithium ions). The material is, for example, the positive electrode active material 204.

Examples of the positive electrode active material 204 include a lithium-containing transition metal oxide, a transition metal fluoride, a polyanion material, a fluorinated polyanion material, a transition metal sulfide, a transition metal oxyfluoride, a transition metal oxysulfide, and a transition metal oxynitride. Examples of the lithium-containing transition metal oxide include Li(Ni,Co,Al)O₂, LiCoO₂, and Li(Ni,Co, Mn)O₂. From the viewpoint of energy density of the battery, a suitable example of the positive electrode active material 204 is Li(Ni,Co,Mn)O₂. Li(Ni,Co,Mn)O₂ can be charged and discharged at a potential of 4 V or more.

In the present disclosure, “(A,B,C)” means “at least one selected from the group consisting of A, B, and C”, where A, B, and C each represent an element.

The positive electrode active material 204 is not limited to a particular shape. The positive electrode active material 204 may be particulate. The positive electrode active material 204 may have a median diameter of 0.1 μm or more and 100 μm or less. In the case where the positive electrode active material 204 has a median diameter of 0.1 μm or more, the positive electrode active material 204 and the solid electrolyte 100 can be favorably dispersed in the positive electrode 201. This enhances the charge and discharge characteristics of the battery 1000. In the case where the positive electrode active material 204 has a median diameter of 100 μm or less, the diffusion rate of lithium inside the positive electrode active material 204 is enhanced. This enables the battery 1000 to operate at a high output.

The positive electrode active material 204 may have a larger median diameter than the solid electrolyte 100 has. In this case, the positive electrode active material 204 and the solid electrolyte 100 can be favorably dispersed in the positive electrode 201.

To enhance the energy density and output of the battery 1000, in the positive electrode 201, the ratio of the volume of the positive electrode active material 204 to the sum of the volume of the positive electrode active material 204 and the volume of the solid electrolyte 100 may be 0.30 or more and 0.95 or less.

To enhance the energy density and output of the battery 1000, the positive electrode 201 may have a thickness of 10 μm or more and 500 μm or less.

The electrolyte layer 202 includes an electrolyte material. The electrolyte material is, for example, a solid electrolyte material. The electrolyte layer 202 may be a solid electrolyte layer.

The solid electrolyte material included in the electrolyte layer 202 may include the solid electrolyte material according to Embodiment 1. The electrolyte layer 202 may include the solid electrolyte material according to Embodiment 1. The solid electrolyte material according to Embodiment 1 may account for 50 mass % or more of the electrolyte layer 202. The solid electrolyte material according to Embodiment 1 may account for 70 mass % or more of the electrolyte layer 202. The solid electrolyte material according to Embodiment 1 may account for 90 mass % or more of the electrolyte layer 202. The electrolyte layer 202 may consist of the solid electrolyte material according to Embodiment 1.

The solid electrolyte material according to Embodiment 1 is hereinafter referred to as a first solid electrolyte material. A solid electrolyte material different from the first solid electrolyte material is hereinafter referred to as a second solid electrolyte material.

The electrolyte layer 202 may include the first solid electrolyte material, and in addition, include the second solid electrolyte material. In the electrolyte layer 202, the first solid electrolyte material and the second solid electrolyte material may be uniformly dispersed. A layer consisting of the first solid electrolyte material and a layer consisting of the second solid electrolyte material may be stacked along the stacking direction for the battery 1000.

The electrolyte layer 202 may consist of the second solid electrolyte material.

Examples of the second solid electrolyte material include Li₂MgX′₄, Li₂FeX′₄, Li(Al,Ga,In)X′₄, Li₃(Al,Ga,In)X′₆, and LiX′, where X′ is at least one selected from the group consisting of F, Cl, Br, and I.

The electrolyte layer 202 may have a thickness of 1 μm or more and 100 μm or less. In the case where the electrolyte layer 202 has a thickness of 1 μm or more, the positive electrode 201 and the negative electrode 203 are less prone to be short-circuited. In the case where the electrolyte layer 202 has a thickness of 100 μm or less, the battery 1000 can operate at a high output.

The negative electrode 203 includes a material capable of occluding and releasing metal ions (e.g., lithium ions). The material is, for example, the negative electrode active material 205.

Examples of the negative electrode active material 205 include a metal material, a carbon material, an oxide, a nitride, a tin compound, and a silicon compound. The metal material may be a simple substance of metal or an alloy. Examples of the metal material include lithium metal and a lithium alloy. Examples of the carbon material include natural graphite, coke, partially graphitized carbon, a carbon fiber, spherical carbon, artificial graphite, and amorphous carbon. From the viewpoint of capacity density, suitable examples of the negative electrode active material include silicon (i.e., Si), tin (i.e., Sn), a silicon compound, and a tin compound. In the case where an active material having a low average discharge voltage, such as graphite, is used as the negative electrode active material 205, the energy density of the battery 1000 can be enhanced.

The negative electrode active material 205 is not limited to a particular shape. The negative electrode active material 205 may be particulate. The negative electrode active material 205 may have a median diameter of 0.1 μm or more and 100 μm or less. In the case where the negative electrode active material 205 has a median diameter of 0.1 μm or more, the negative electrode active material 205 and the solid electrolyte 100 can be favorably dispersed in the negative electrode 203. This enhances the charge and discharge characteristics of the battery 1000. In the case where the negative electrode active material 205 has a median diameter of 100 μm or less, the diffusion rate of lithium inside the negative electrode active material 205 is enhanced. This enables the battery 1000 to operate at a high output.

The negative electrode active material 205 may have a larger median diameter than the solid electrolyte 100 has. In this case, a favorable dispersion state of the negative electrode active material 205 and the solid electrolyte 100 is achieved in the negative electrode 203.

To enhance the energy density and output of the battery 1000, in the negative electrode 203, the ratio of the volume of the negative electrode active material 205 to the sum of the volume of the negative electrode active material 205 and the volume of the solid electrolyte 100 may be 0.30 or more and 0.95 or less.

To enhance the energy density and output of the battery 1000, the negative electrode 203 may have a thickness of 10 μm or more and 500 μm or less.

At least one selected from the group consisting of the positive electrode 201, the electrolyte layer 202, and the negative electrode 203 may include the second solid electrolyte material for the purpose of enhancing the ionic conductivity, chemical stability, and electrochemical stability. Examples of the second solid electrolyte material include a sulfide solid electrolyte, an oxide solid electrolyte, a halide solid electrolyte, and an organic polymer solid electrolyte.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

Examples of the oxide solid electrolyte include:
(i) a NASICON solid electrolyte, such as LiTi₂(PO₄)₃ or its element-substituted substance;
(ii) a perovskite solid electrolyte, such as (LaLi)TiO₃;
(iii) a LISICON solid electrolyte, such as Li₁₄ZnGe₄O₁₆, Li₄SiO₄, LiGeO₄, or its element-substituted substance;
(iv) a garnet solid electrolyte, such as Li₂La₃Zr₂O₁₂ or its element-substituted substance; and
(v) Li₃PO₄ and its N-substituted substance.

Examples of the halide solid electrolyte include Li₂MgX′₄, Li₂FeX′₄, Li(Al,Ga,In)X′₄, Li₃(Al,Ga,In)X′₆, and LiX′, as described above.

Another example of the halide solid electrolyte is a compound represented by LiₚMe_{q}YᵣZ₆, where p+m′q+3r=6 and r>0 are satisfied, Me is at least one element selected from the group consisting of metalloid elements and metal elements other than Li or Y, the value of m′ represents the valence of Me, and Z is at least one selected from the group consisting of F, Cl, Br, and I. The “metalloid elements” refer to B, Si, Ge, As, Sb, and Te. The “metal elements” refer to all the elements included in Groups 1 to 12 of the periodic table (except hydrogen) and all the elements included in Groups 13 to 16 of the periodic table (except B, Si, Ge, As, Sb, Te, C, N, P, O, S, and Se).

To enhance the ionic conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

The halide solid electrolyte may be Li₃YCl₆ or Li₃YBr₆.

An example of the organic polymer solid electrolyte is a compound of a polymer compound and a lithium salt.

The polymer compound may have an ethylene oxide structure. The polymer compound having an ethylene oxide structure can contain a large amount of a lithium salt, and accordingly can enhance the ionic conductivity.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone. Alternatively, a mixture of two or more lithium salts selected from these may be used.

At least one selected from the group consisting of the positive electrode 201, the electrolyte layer 202, and the negative electrode 203 may include a nonaqueous electrolyte solution, a gel electrolyte, or an ionic liquid for the purpose of facilitating transfer of lithium ions to enhance the output characteristics of the battery 1000.

The nonaqueous electrolyte solution contains a nonaqueous solvent and a lithium salt dissolved in the nonaqueous solvent.

Examples of the nonaqueous solvent include a cyclic carbonate solvent, a chain carbonate solvent, a cyclic ether solvent, a chain ether solvent, a cyclic ester solvent, a chain ester solvent, and a fluorinated solvent. Examples of the cyclic carbonate solvent include ethylene carbonate, propylene carbonate, and butylene carbonate. Examples of the chain carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the chain ether solvent include 1,2-dimethoxyethane and 1,2-diethoxyethane. Examples of the cyclic ester solvent include y-butyrolactone. Examples of the chain ester solvent include methyl acetate. Examples of the fluorinated solvent include fluoroethylene carbonate, methyl fluoropropionate, fluorobenzene, fluoroethyl methyl carbonate, and fluorodimethylene carbonate. One nonaqueous solvent selected from these may be used alone. Alternatively, a mixture of two or more nonaqueous solvents selected from these may be used.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone. Alternatively, a mixture of two or more lithium salts selected from these may be used.

The lithium salt has a concentration of, for example, 0.5 mol/L or more and 2 mol/L or less.

The gel electrolyte can be a polymer material impregnated with a nonaqueous electrolyte solution. Examples of the polymer material include polyethylene oxide, polyacrylonitrile, polyvinylidene fluoride, polymethyl methacrylate, and a polymer having an ethylene oxide bond.

Examples of the cation contained in the ionic liquid include:
(i) an aliphatic chain quaternary salt, such as tetraalkylammonium or tetraalkylphosphonium;
(ii) an aliphatic cyclic ammonium, such as pyrrolidinium, morpholinium, imidazolinium, tetrahydropyrimidinium, piperazinium, or piperidinium; and
(iii) a nitrogen-containing heterocyclic aromatic cation, such as pyridinium or imidazolium.

Examples of the anion contained in the ionic liquid include PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻.

The ionic liquid may contain a lithium salt.

At least one selected from the group consisting of the positive electrode 201, the electrolyte layer 202, and the negative electrode 203 may include a binder in order to enhance the adhesion between the particles.

Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. The binder can also be a copolymer. Examples of such a binder include a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more selected from the above materials may be used as the binder.

At least one selected from the positive electrode 201 and the negative electrode 203 may include a conductive additive in order to enhance the electronic conductivity.

Examples of the conductive additive include:
(i) graphite, such as natural graphite or artificial graphite;
(ii) carbon black, such as acetylene black or Ketjenblack;
(iii) a conductive fiber, such as a carbon fiber or a metal fiber;
(iv) fluorinated carbon;
(v) a metal powder, such as an aluminum powder;
(vi) a conductive whisker, such as a zinc oxide whisker or a potassium titanate whisker;
(vii) a conductive metal oxide, such as titanium oxide; and
(viii) a conductive polymer compound, such as polyaniline compound, polypyrrole compound, or polythiophene compound. To reduce the cost, the conductive additive in the above (i) or (ii) may be used.

Examples of the shape of the battery according to Embodiment 2 include a coin type, a cylindrical type, a prismatic type, a sheet type, a button type, a flat type, and a stacked type.

The battery according to Embodiment 2 may be manufactured by, for example, preparing a material for forming a positive electrode, a material for forming an electrolyte layer, and a material for forming a negative electrode, and producing by a known method a stack composed of the positive electrode, the electrolyte layer, and the negative electrode disposed in this order.

### EXAMPLES

The present disclosure will be described in more detail below with reference to examples and comparative examples.

### Example 1-1

### [Production of Solid Electrolyte Material]

In an argon atmosphere with a dew point of −60° C. or lower (hereinafter referred to as a “dry argon atmosphere”), LiCl, AlCl₃, Al₂O₃, and SiO₂ were prepared as the raw material powders at a molar ratio of LiCl:AlCl₃:Al₂O₃:SiO₂=0.299:0.292:0.356:0.0528. These raw material powders were mixed and milled in a planetary ball mill at 500 rpm for 12 hours. Thus, a powder of a solid electrolyte material according to Example 1-1 was obtained. Here, the composition of the solid electrolyte material obtained is expressed in charge ratio because a preliminary experiment demonstrated that the measured value of the composition of the solid electrolyte material was almost equal to its charge ratio. The solid electrolyte material according to Example 1-1 had composition represented by Li_{0.298} Si_{0.0526}AlO_{1.17}Cl_{1.17}.

### [Crystal Structure Analysis]

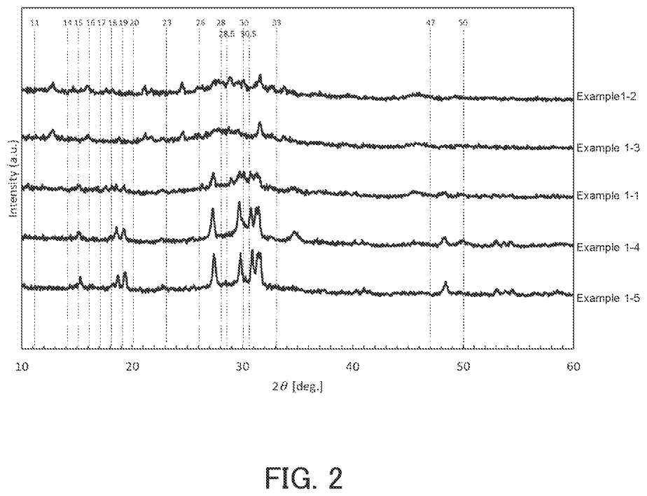

FIG. 2 is a graph showing the X-ray diffraction pattern of the solid electrolyte material according to Example 1-1.

In a dry atmosphere with a dew point of −30° C. or lower, the X-ray diffraction pattern of the solid electrolyte material according to Example 1-1 was measured with an X-ray diffractometer (MiniFlex 600 manufactured by Rigaku Corporation). The X-ray source used was Cu-Kα radiation.

In the X-ray diffraction pattern of the solid electrolyte material according to Example 1-1, peaks were present at diffraction angles 2θ of 15.06°, 18.53°, 19.27°, 27.33°, 29.74°, 30.09°, 30.70°, 31.27°, 31.52°, and 48.36°.

### [Ionic Conductivity Measurement]

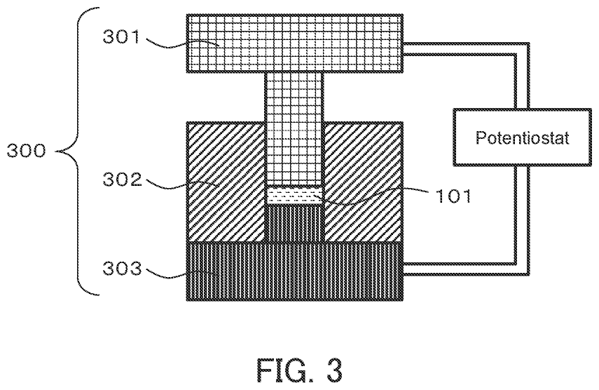

FIG. 3 is a schematic view of a pressure-molding die 300 for use in evaluating the ionic conductivity of solid electrolyte materials.

The pressure-molding die 300 included an upper punch 301, a die 302, and a lower punch 303. The upper punch 301 and the lower punch 303 were made of stainless steel, which is electronically conductive. The die 302 was made of polycarbonate, which is insulating.

The pressure-molding die 300 shown in FIG. 3 was used to measure the ionic conductivity of the solid electrolyte material according to Example 1-1 by the following method.

In a dry argon atmosphere, the pressure-molding die 300 was filled with the powder of the solid electrolyte material according to Example 1-1 (i.e., a solid electrolyte material powder 101 in FIG. 3). Inside the pressure-molding die 300, a pressure of 300 MPa was applied to the powder of the solid electrolyte material according to Example 1-1 with the upper punch 301 and the lower punch 303.

While the pressure was applied, the upper punch 301 and the lower punch 303 were connected to a potentiostat (VSP-300 manufactured by Bio-Logic SAS) equipped with a frequency response analyzer. The upper punch 301 was connected to the working electrode and the potential measurement terminal. The lower punch 303 was connected to the counter electrode and the reference electrode. The ionic conductivity of the solid electrolyte material was measured at room temperature by electrochemical impedance measurement.

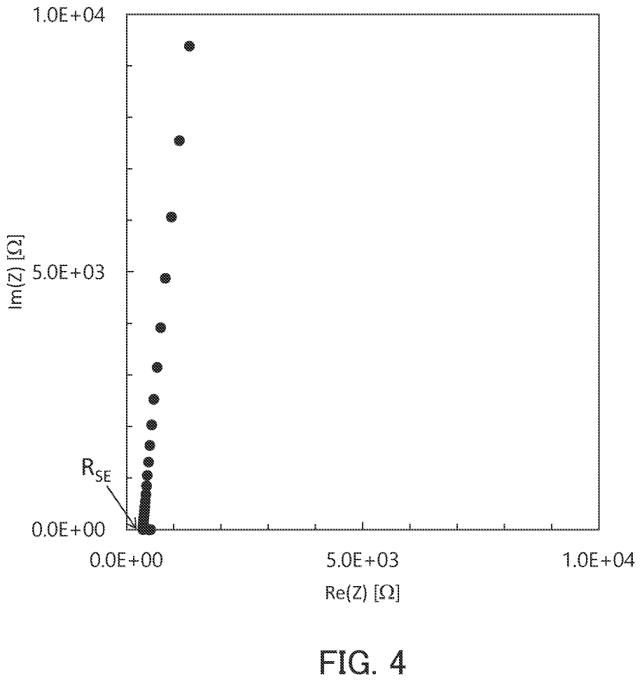

FIG. 4 is a graph showing a Cole-Cole plot obtained by the impedance measurement of the solid electrolyte material according to Example 1-1.

In FIG. 4, the real part of the complex impedance at the measurement point where the absolute value of the phase of the complex impedance was smallest was defined as the resistance value of the solid electrolyte material to ion conduction. For the real part, see an arrow R_{SE} shown in FIG. 4. The ionic conductivity was calculated from the resistance value by the following mathematical equation (4):

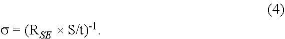

Here, σ represents the ionic conductivity. S represents the contact area of the solid electrolyte material with the upper punch 301. S is equal to the cross-sectional area of the cavity of the die 302 in FIG. 3. R_{SE} represents the resistance value of the solid electrolyte material in the impedance measurement. The symbol t represents the thickness of the solid electrolyte material with the pressure applied. This thickness is equal to the thickness of the layer formed of the solid electrolyte material powder 101 in FIG. 3.

The ionic conductivity of the solid electrolyte material according to Example 1-1 measured at 25° C. was 2.38×10⁻⁴ S/cm.

### [Production of Battery]

In a dry argon atmosphere, the solid electrolyte material according to Example 1-1 and a positive electrode active material Li(Ni,Co,Mn)O₂ (hereinafter referred to as “NCM”) were prepared at a mass ratio of 24:76. These materials were mixed in an agate mortar to obtain a positive electrode mixture according to Example 1-1.

In an insulating cylinder having an inner diameter of 9.5 mm, a sulfide solid electrolyte Li₂S—P₂S₅ (hereinafter referred to as “LPS”) (60 mg) and the solid electrolyte material according to Example 1-1 (24 mg) were stacked in order. Thus, a stack was obtained. A pressure of 160 MPa was applied to this stack to form a solid electrolyte layer.

Next, the positive electrode mixture (9.2 mg) according to Example 1-1 was stacked on the stacking side of the solid electrolyte material according to Example 1-1 in the solid electrolyte layer to obtain a stack. A pressure of 360 MPa was applied to this stack to form a positive electrode.

Next, a metallic Li foil (thickness: 300 μm) was stacked on the stacking side of LPS in the solid electrolyte layer to obtain a stack. A pressure of 80 MPa was applied to this stack to form a negative electrode.

Current collectors made of stainless steel were disposed on the positive electrode and the negative electrode, and current collector leads were attached to the current collectors.

Finally, an insulating ferrule was used to block the inside of the insulating cylinder from the outside air atmosphere to hermetically seal the cylinder. Thus, a battery according to Example 1-1 was obtained.

### [Charge and Discharge Measurement]

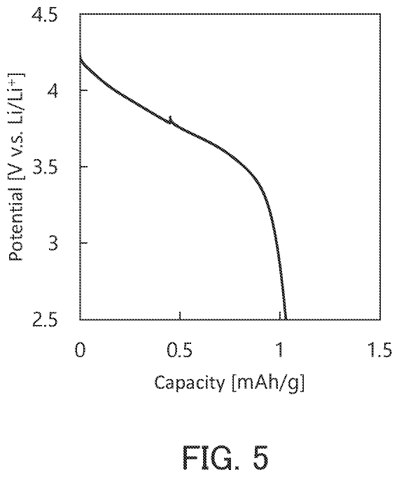

FIG. 5 is a graph showing the initial discharge characteristics of the battery according to Example 1-1. The initial discharge characteristics were measured by the following method.

The battery according to Example 1-1 was placed in a thermostatic chamber set at 25° C.

The battery according to Example 1-1 was charged at a current density of 105 μA/cm² until the positive electrode reached a voltage of 4.30 V relative to the negative electrode. This current density is equivalent to 0.05 C rate (i.e., 20-hour rate) relative to the theoretical capacity of the battery. Charge refers to a state where an electric current flows in a direction in which lithium ions migrate from the positive electrode including NCM to Li metal (i.e., the negative electrode).

Next, the battery according to Example 1-1 was discharged at a current density of 105 μA/cm² until the positive electrode reached a voltage of 1.88 V relative to the negative electrode. This current density is equivalent to 0.05 C rate (i.e., 20-hour rate) relative to the theoretical capacity of the battery. Discharge refers to a state where an electric current flows in a direction in which lithium ions migrate from Li metal (i.e., the negative electrode) to the positive electrode including NCM.

The results of the charge and discharge test indicate the battery according to Example 1-1 had an initial discharge capacity of 1.03 mAh.

### Examples 1-2 to 1-5

### [Production of Solid Electrolyte Material]

In Example 1-2, LiCl, AlCl₃, Al₂O₃, and SiO₂ were prepared as the raw material powders in a dry argon atmosphere at a molar ratio of LiCl:AlCl₃:Al₂O₃:SiO₂=0.251:0.315:0.327:0.108.

In Example 1-3, LiCl, AlCl₃, Al₂O₃, and SiO₂ were prepared as the raw material powders in a dry argon atmosphere at a molar ratio of LiCl:AlCl₃:Al₂O₃:SiO₂=0.201:0.339:0.296:0.164.

In Example 1-4, LiCl, AlCl₃, Al₂O₃, and SiO₂ were prepared as the raw material powders in a dry argon atmosphere at a molar ratio of LiCl:AlCl₃:Al₂O₃:SiO₂=0.405:0.297:0.216:0.081.

In Example 1-5, LiCl, AlCl₃, Al₂O₃, and SiO₂ were prepared as the raw material powders in a dry argon atmosphere at a molar ratio of LiCl:AlCl₃:Al₂O₃:SiO₂=0.333:0.333:0.167:0.167.

In the same manner as in Example 1-1 except for the above matters, solid electrolyte materials according to Examples 1-2 to 1-5 were obtained.

### [Ionic Conductivity Evaluation]

The solid electrolyte materials according to Examples 1-2 to 1-5 were subjected to measurement of ionic conductivity in the same manner as in Example 1-1. Table 1 shows the ionic conductivities of the solid electrolyte materials according to Examples 1-2 to 1-5.

### [Crystal Structure Analysis]

The solid electrolyte materials according to Examples 1-2 to 1-5 were subjected to measurement of X-ray diffraction pattern in the same manner as in Example 1-1. The graph in FIG. 2 shows the X-ray diffraction patterns of the solid electrolyte materials according to Examples 1-2 to 1-5. Table 2 shows the positions of peaks observed.

### Example 2-1

### [Production of Solid Electrolyte Material]

In an argon atmosphere with a dew point of −60° C. or lower (hereinafter referred to as a “dry argon atmosphere”), LiCl, AlCl₃, MgCl₂, and Al₂O₃ were prepared as the raw material powders at a molar ratio of LiCl:AlCl₃:MgCl₂:Al₂O₃=0.408:0.150:0.0941:0.348. The mixture of these raw material powders was milled in a planetary ball mill at 500 rpm for 12 hours. Thus, a powder of a solid electrolyte material according to Example 2-1 was obtained. Here, the composition of the solid electrolyte material obtained is expressed in charge ratio because a preliminary experiment demonstrated that the measured value of the composition of the solid electrolyte material was almost equal to its charge ratio. The solid electrolyte material according to Example 2-1 had composition represented by Li_{0.481}Mg_{0.111}AlO_{1.23}Cl_{1.23}.

### [Crystal Structure Analysis]

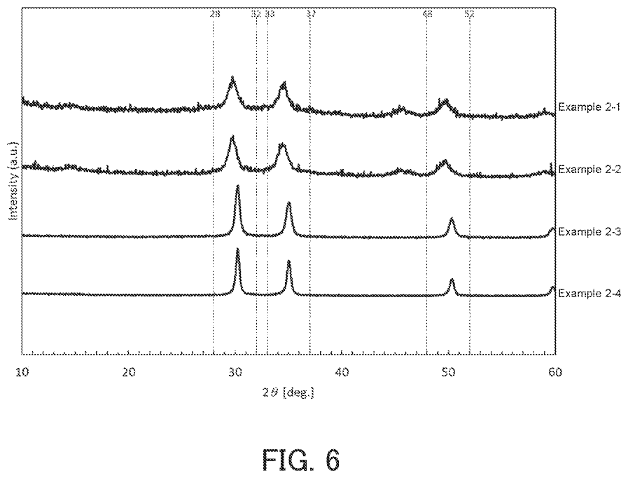

The solid electrolyte material according to Example 2-1 was subjected to measurement of X-ray diffraction pattern in the same manner as in Example 1-1. FIG. 6 is a graph showing the X-ray diffraction pattern of the solid electrolyte material according to Example 2-1.

In the X-ray diffraction pattern of the solid electrolyte material according to Example 2-1, peaks were present at diffraction angles 2θ of 29.79°, 34.64°, and 49.89°.

### [Ionic Conductivity Measurement]

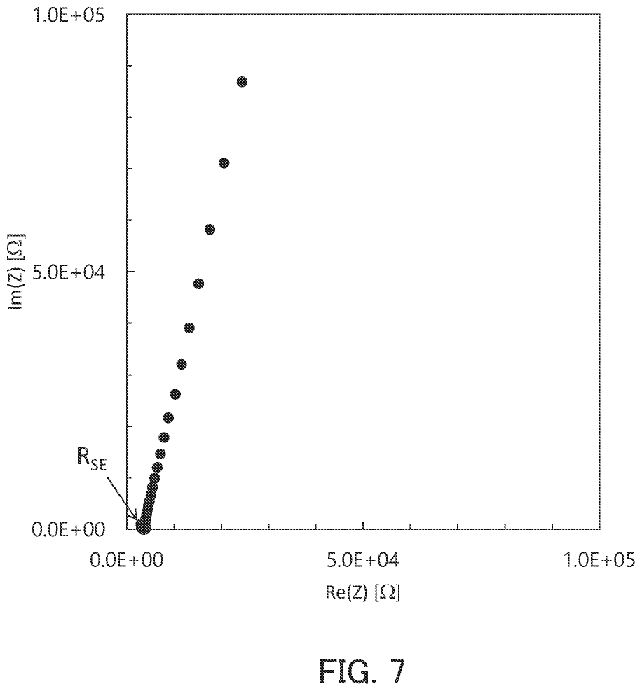

The solid electrolyte materials according to Example 2-1 was subjected to measurement of ionic conductivity in the same manner as in Example 1-1. FIG. 7 is a graph showing a Cole-Cole plot obtained by impedance measurement of the solid electrolyte material according to Example 2-1.

The ionic conductivity of the solid electrolyte material according to Example 2-1 measured at 25° C. was 1.79×10⁻⁵ S/cm.

### [Production of Battery]

In the same manner as in Example 1-1, a battery according to Example 2-1 was obtained with use of the solid electrolyte material according to Example 2-1.

### [Charge and Discharge Measurement]

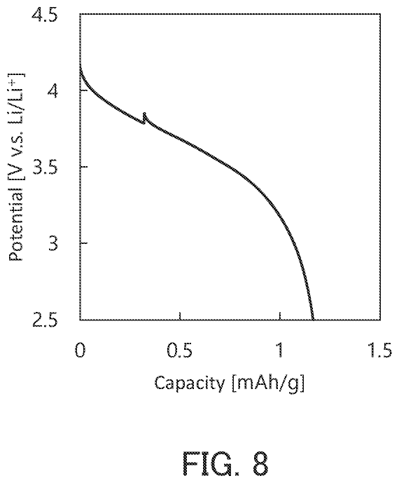

FIG. 8 is a graph showing the initial discharge characteristics of the battery according to Example 2-1. The initial discharge characteristics were measured by the following method.

The battery according to Example 2-1 was placed in a thermostatic chamber set at 25° C.

The battery according to Example 2-1 was charged at a current density of 105 μA/cm² until the positive electrode reached a voltage of 4.30 V relative to the negative electrode. This current density is equivalent to 0.05 C rate (i.e., 20-hour rate) relative to the theoretical capacity of the battery. Charge refers to a state where an electric current flows in a direction in which lithium ions migrate from the positive electrode including NCM to Li metal (i.e., the negative electrode).

Next, the battery according to Example 2-1 was discharged at a current density of 105 μA/cm² until the positive electrode reached a voltage of 2.50 V relative to the negative electrode. This current density is equivalent to 0.05 C rate (i.e., 20-hour rate) relative to the theoretical capacity of the battery. Discharge refers to a state where an electric current flows in a direction in which lithium ions migrate from Li metal (i.e., the negative electrode) to the positive electrode including NCM.

The results of the charge and discharge test indicate that the battery according to Example 2-1 had an initial discharge capacity of 1.17 mAh.

### Examples 2-2 to 2-4 and Comparative Examples 2-1 to 2-2

### [Production of Solid Electrolyte Material]

In Example 2-2, LiCl, MgCl₂, AlCl₃, and Al₂O₃ were prepared as the raw material powders in a dry argon atmosphere at a molar ratio of LiCl:MgCl₂:AlCl₃:Al₂O₃=0.459:0.172:0.0510:0.318.

In Example 2-3, LiCl, MgCl₂, AlCl₃, and Al₂O₃ were prepared as the raw material powders in a dry argon atmosphere at a molar ratio of LiCl:MgCl₂:AlCl₃:Al₂O₃=0.823:0.0265:0.0619:0.0885.

In Example 2-4, LiCl, MgCl₂, AlCl₃, and Al₂O₃ were prepared as the raw material powders in a dry argon atmosphere at a molar ratio of LiCl:MgCl₂:AlCl₃:Al₂O₃=0.832:0.0756:0.00840:0.0840.

In Comparative Example 2-1, LiCl, CaCl₂), AlCl₃, and Al₂O₃ were prepared as the raw material powders in a dry argon atmosphere at a molar ratio of LiCl:CaCl₂):AlCl₃:Al₂O₃=0.823:0.0265:0.0619:0.0885.

In Comparative Example 2-2, LiCl, CaCl₂), AlCl₃, and Al₂O₃ were prepared as the raw material powders in a dry argon atmosphere at a molar ratio of LiCl:CaCl₂):AlCl₃:Al₂O₃=0.828:0.0517:0.0345:0.0862.

In the same manner as in Example 2-1 except for the above matters, solid electrolyte materials according to Examples 2-2 to 2-4 and Comparative Examples 2-1 to 2-2 were obtained.

### [Ionic Conductivity Evaluation]

The solid electrolyte materials according to Examples 2-2 to 2-4 and Comparative Examples 2-1 to 2-2 were subjected to measurement of ionic conductivity in the same manner as in Example 1-1. Table 3 shows the ionic conductivities of the solid electrolyte materials according to Examples 2-2 to 2-4. Table 4 shows the ionic conductivities of the solid electrolyte materials according to Comparative Examples 2-1 to 2-2.

### [Crystal Structure Analysis]

The solid electrolyte materials according to Examples 2-2 to 2-4 were subjected to measurement of X-ray diffraction pattern in the same manner as in Example 1-1. The graph in FIG. 6 shows the X-ray diffraction patterns of the solid electrolyte materials according to Examples 2-2 to 2-4. Table 5 shows the positions of peaks observed.

### Example 3-1

### [Production of Solid Electrolyte Material]

In an argon atmosphere with a dew point of −60° C. or lower (hereinafter referred to as a “dry argon atmosphere”), LiCl, Li₂O, and CrCl₃ were prepared as the raw material powders at a molar ratio of LiCl:Li₂O:CrCl₃=0.333:0.333:0.333. The mixture of these raw material powders was milled in a planetary ball mill at 500 rpm for 12 hours. Thus, a powder of a solid electrolyte material according to Example 3-1 was obtained. Here, the composition of the solid electrolyte material obtained is expressed in charge ratio because a preliminary experiment demonstrated that the measured value of the composition of the solid electrolyte material was almost equal to its charge ratio. The solid electrolyte material according to Example 3-1 had composition represented by Li₃CrOCl₄.

### [Crystal Structure Analysis]

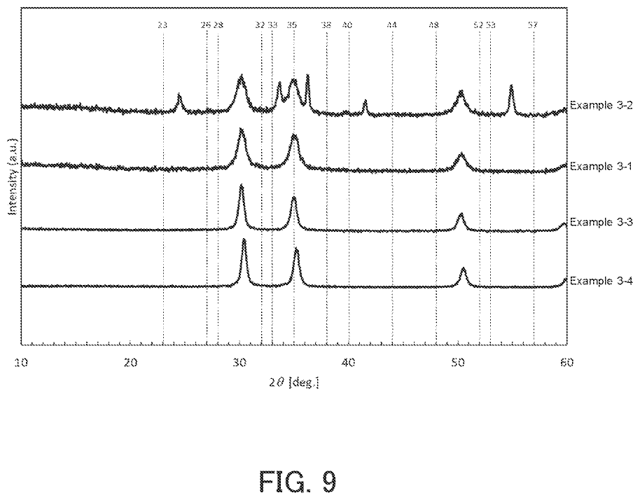

The solid electrolyte material according to Example 3-1 was subjected to measurement of X-ray diffraction pattern in the same manner as in Example 1-1. FIG. 9 is a graph showing the X-ray diffraction pattern of the solid electrolyte material according to Example 3-1.

In the X-ray diffraction pattern of the solid electrolyte material according to Example 3-1, peaks were present at diffraction angles 2θ of 30.30°, 35.22°, and 50.37°.

### [Ionic Conductivity Measurement]

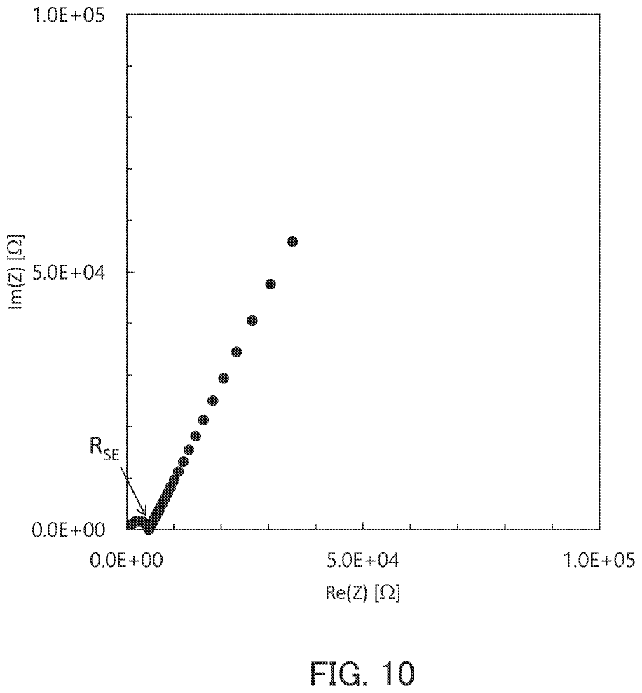

The solid electrolyte material according to Example 3-1 was subjected to measurement of ionic conductivity in the same manner as in Example 1-1. FIG. 10 is a graph showing a Cole-Cole plot obtained by impedance measurement of the solid electrolyte material according to Example 3-1.

The ionic conductivity of the solid electrolyte material according to Example 3-1 measured at 25° C. was 2.03×10⁻⁵ S/cm.

### [Production of Battery]

In the same manner as in Example 1-1, a battery according to Example 3-1 was obtained with use of the solid electrolyte material according to Example 3-1.

### [Charge and Discharge Measurement]

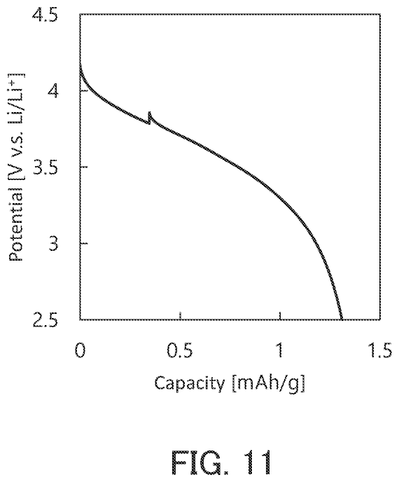

FIG. 11 is a graph showing the initial discharge characteristics of the battery according to Example 3-1. The initial discharge characteristics were measured by the following method.

The battery according to Example 3-1 was placed in a thermostatic chamber set at 25° ° C.

The battery according to Example 3-1 was charged at a current density of 105 μA/cm² until the positive electrode reached a voltage of 4.30 V relative to the negative electrode. This current density is equivalent to 0.05 C rate (i.e., 20-hour rate) relative to the theoretical capacity of the battery. Charge refers to a state where an electric current flows in a direction in which lithium ions migrate from the positive electrode including NCM to Li metal (i.e., the negative electrode).

Next, the battery according to Example 3-1 was discharged at a current density of 105 μA/cm² until the positive electrode reached a voltage of 2.50 V relative to the negative electrode. This current density is equivalent to 0.05 C rate (i.e., 20-hour rate) relative to the theoretical capacity of the battery. Discharge refers to a state where an electric current flows in a direction in which lithium ions migrate from Li metal (i.e., the negative electrode) to the positive electrode including NCM.

The results of the charge and discharge test indicate that the battery according to Example 3-1 had an initial discharge capacity of 1.31 mAh.

### Examples 3-2 to 3-4 and Comparative Example 3-1

### [Production of Solid Electrolyte Material]

In Example 3-2, Li₂O and CrCl₃ were prepared as the raw material powders in a dry argon atmosphere at a molar ratio of Li₂O:CrCl₃=0.500:0.500.

In Example 3-3, LiCl, Li₂O, CrCl₃, and AlCl₃ were prepared as the raw material powders in a dry argon atmosphere at a molar ratio of LiCl:Li₂O:CrCl₃:AlCl₃=0.333:0.333:0.0333:0.300.

In Example 3-4, LiCl, Li₂O, CrCl₃, and AlCl₃ were prepared as the raw material powders in a dry argon atmosphere at a molar ratio of LiCl:Li₂O:CrCl₃:AlCl₃=0.333:0.333:0.0667:0.267.

In Comparative Example 3-1, LiCl, Li₂O, and AlCl₃ were prepared as the raw material powders in a dry argon atmosphere at a molar ratio of LiCl:Li₂O:AlCl₃=0.333:0.333:0.333.

In the same manner as in Example 3-1 except for the above matters, solid electrolyte materials according to Examples 3-2 to 3-4 and Comparative Example 3-1 were obtained.

### [Ionic Conductivity Evaluation]

The solid electrolyte materials according to Examples 3-2 to 3-4 and Comparative Example 3-1 were subjected to measurement of ionic conductivity in the same manner as in Example 1-1. Table 6 shows the ionic conductivities of the solid electrolyte materials according to Examples 3-2 to 3-4 and Comparative Example 3-1.

### [Crystal Structure Analysis]

The solid electrolyte materials according to Examples 3-2 to 3-4 were subjected to measurement of X-ray diffraction pattern in the same manner as in Example 3-1. The graph in FIG. 9 shows the X-ray diffraction patterns of the solid electrolyte materials according to Examples 3-2 to 3-4. Table 7 shows the positions of peaks observed.

TABLE 1

| | Element ratio (Molar ratio) | | | | | | | | Ionic |
|---|---|---|---|---|---|---|---|---|---|
| | Li | Si | Al | O | Cl | | c1/ | e1/ | conductivity |
| | a1 | b1 | c1 | d1 | e1 | b1/c1 | (a1 + c1) | (d1 + e1) | (S/cm) |
| Example | 0.298 | 0.0526 | 1.00 | 1.17 | 1.17 | 0.0526 | 0.770 | 0.500 | 2.38 × 10⁻⁴ |
| 1-1 | | | | | | | | | |
| Example | 0.259 | 0.111 | 1.00 | 1.23 | 1.23 | 0.111 | 0.794 | 0.500 | 1.76 × 10⁻⁴ |
| 1-2 | | | | | | | | | |
| Example | 0.216 | 0.176 | 1.00 | 1.31 | 1.31 | 0.176 | 0.823 | 0.500 | 1.25 × 10⁻⁴ |
| 1-3 | | | | | | | | | |
| Example | 0.556 | 0.111 | 1.00 | 1.11 | 1.78 | 0.111 | 0.643 | 0.615 | 1.40 × 10⁻⁴ |
| 1-4 | | | | | | | | | |
| Example | 0.500 | 0.250 | 1.00 | 1.25 | 2.00 | 0.250 | 0.667 | 0.615 | 1.25 × 10⁻⁴ |
| 1-5 | | | | | | | | | |

TABLE 2

| | XRD peak position (°) |
|---|---|
| Example 1-1 | 15.06, 18.53, 19.27, 27.33, 29.74, |
| | 30.09, 30.70, 31.27, 31.52, 48.36 |
| Example 1-2 | 12.91, 16.05, 21.22, 21.95, 24.59, |
| | 27.68, 28.92, 31.65, 32.81 |
| Example 1-3 | 12.85, 16.00, 21.23, 21.84, 24.61, |
| | 27.41, 28.75, 31.56, 32.71 |
| Example 1-4 | 15.17, 18.58, 19.22, 27.31, 29.71, |
| | 30.77, 31.24, 31.47, 48.28 |
| Example 1-5 | 15.28, 18.71, 19.41, 27.42, 29.82, |
| | 30.91, 31.36, 31.63, 48.41 |

TABLE 3

| | Element ratio (Molar ratio) | | | | | | | | Ionic |
|---|---|---|---|---|---|---|---|---|---|
| | Li | Mg | Al | O | Cl | | c2/ | e2/ | conductivity |
| | a2 | b2 | c2 | d2 | e2 | b2/c2 | (a2 + c2) | (d2 + e2) | (S/cm) |
| Example | 0.481 | 0.111 | 1.00 | 1.23 | 1.23 | 0.111 | 0.675 | 0.500 | 1.79 × 10⁻⁵ |
| 2-1 | | | | | | | | | |
| Example | 0.667 | 0.250 | 1.00 | 1.39 | 1.39 | 0.250 | 0.600 | 0.500 | 1.86 × 10⁻⁶ |
| 2-2 | | | | | | | | | |
| Example | 3.44 | 0.111 | 1.00 | 1.11 | 4.44 | 0.111 | 0.225 | 0.800 | 6.47 × 10⁻⁷ |
| 2-3 | | | | | | | | | |
| Example | 4.71 | 0.429 | 1.00 | 1.43 | 5.71 | 0.429 | 0.175 | 0.800 | 4.56 × 10⁻⁷ |
| 2-4 | | | | | | | | | |

TABLE 4

| | Element ratio (Molar ratio) | | | | | Ionic |
|---|---|---|---|---|---|---|
| | Li | Ca | Al | O | Cl | conductivity |
| | a2 | b2 | c2 | d2 | e2 | (S/cm) |
| Comparative | 3.44 | 0.111 | 1.00 | 1.11 | 4.44 | 1.54 × 10⁻⁹ |
| Example 2-1 | | | | | | |
| Comparative | 4.00 | 0.250 | 1.00 | 1.25 | 5.00 | 3.02 × 10⁻¹⁰ |
| Example 2-2 | | | | | | |

TABLE 5

XRD peak position

| | | | |
|---|---|---|---|
| Example 2-1 | 29.79 | 34.64 | 49.89 |
| Example 2-2 | 29.85 | 34.50 | 49.48 |
| Example 2-3 | 30.30 | 35.15 | 50.34 |
| Example 2-4 | 30.29 | 35.10 | 50.39 |

TABLE 6

| | Element ratio (Molar ratio) | | | | | | | | Ionic |
|---|---|---|---|---|---|---|---|---|---|
| | Li | Cr | Al | O | Cl | | b3/ | e3/ | conductivity |
| | a3 | b3 | c3 | d3 | e3 | c3/b3 | (a3 + b3) | (d3 + e3) | (S/cm) |
| Example | 3.00 | 1.00 | 0 | 1.00 | 4.00 | 0 | 0.250 | 0.800 | 2.03 × 10⁻⁵ |
| 3-1 | | | | | | | | | |
| Example | 2.00 | 1.00 | 0 | 1.00 | 3.00 | 0 | 0.333 | 0.750 | 9.66 × 10⁻⁶ |
| 3-2 | | | | | | | | | |
| Example | 30.0 | 1.00 | 9.00 | 10.0 | 40.0 | 9.00 | 0.0323 | 0.800 | 1.93 × 10⁻⁶ |
| 3-3 | | | | | | | | | |
| Example | 15.0 | 1.00 | 4.00 | 5.00 | 20.0 | 4.00 | 0.0625 | 0.800 | 4.23 × 10⁻⁶ |
| 3-4 | | | | | | | | | |
| Comparative | 3.00 | 0 | 1.00 | 1.00 | 4.00 | — | 0 | 0.800 | 2.15 × 10⁻⁷ |
| Example 3-1 | | | | | | | | | |

TABLE 7

| | XRD peak position (°) |
|---|---|
| Example 3-1 | 30.30, 35.22, 50.37 |
| Example 3-2 | 24.54, 30.23, 33.74, 35.14, 36.29, 41.62, 50.24, 55.94 |
| Example 3-3 | 30.30, 35.10, 50.39 |
| Example 3-4 | 30.49, 35.35, 50.58 |

### (Discussion)

As is evident from Table 1, all of the solid electrolyte materials according to Examples 1-1 to 1-5 had a high ionic conductivity of 1.0×10⁻⁴ S/cm or more at near room temperature.

The solid electrolyte materials according to Examples 1-1, 1-4, and 1-5 each had, in the X-ray diffraction pattern obtained by X-ray diffraction measurement using Cu-Kα radiation, at least one peak within each of ranges of the diffraction angle 2θ from 14° to 16°, from 18° to 19°, from more than 19° to 20°, from 26° to 28°, from more than 28° to 30.5°, and from 47° to 50°, and at least three peaks within a range of the diffraction angle 2θ from more than 30.5° to 33°. That is, the solid electrolyte materials according to Examples 1-1, 1-4, and 1-5 included the 1-1st crystalline phase.

The solid electrolyte materials according to Examples 1-2 and 1-3 each had, in the X-ray diffraction pattern, at least one peak within each of ranges of the diffraction angle 20 from 11° to 14°, from 15° to 17°, from more than 23° to 26°, from more than 26° to 28.5°, and from more than 28.5° to 30°, and at least two peaks within each of ranges of the diffraction angle 2θ from 20° to 23° and from 30.5° to 33°. That is, the solid electrolyte materials according to Examples 1-2 and 1-3 included the 1-2nd crystalline phase.

As is evident from Table 3, all of the solid electrolyte materials according to Examples 2-1 to 2-4 had a high ionic conductivity of 4×10⁻⁷ S/cm or more at near room temperature.

As is evident from comparison of Examples 2-1 to 2-4 with Comparative Examples 2-1 and 2-2, it is demonstrated that a solid electrolyte material including Mg has an enhanced ionic conductivity.

The solid electrolyte materials according to Examples 2-1 to 2-4 each had, in the X-ray diffraction pattern obtained by X-ray diffraction measurement using Cu-Kα radiation, a peak within each of ranges of the diffraction angle 2θ from 28° to 32°, from 33° to 37°, and from 48° to 52°. That is, the solid electrolyte materials according to Examples 2-1 to 2-4 included the 2-1st crystalline phase.

As is evident from Table 6, all of the solid electrolyte materials according to Examples 3-1 to 3-4 had a high ionic conductivity of 1.0×10⁻⁵ S/cm or more at near room temperature.

As is evident from comparison of Examples 3-1 to 3-4 with Comparative Example 3-1, it is demonstrated that a solid electrolyte material including Cr has an enhanced ionic conductivity.

The solid electrolyte materials according to Examples 3-1 to 3-4 each had, in the X-ray diffraction pattern obtained by X-ray diffraction measurement using Cu-Kα radiation, a peak within each of ranges of the diffraction angle 2θ from 28° to 32°, from 33° to 37°, and from 48° to 52°. That is, the solid electrolyte materials according to Examples 3-1 to 3-4 included the 3-1st crystalline phase.

The solid electrolyte material according to Example 3-2 had, in the X-ray diffraction pattern obtained by X-ray diffraction measurement using Cu-Kα radiation, a peak within each of ranges of the diffraction angle 2θ from 23° to 27°, from 32° to 35°, from more than 35° to 38°, from 40° to 44°, and from 53° to 57°. That is, the solid electrolyte material according to Example 3-2 included the 3-2nd crystalline phase.

The solid electrolyte materials according to Examples 1-1 to 1-5, 2-1 to 2-4, and 3-1 to 3-4 are free of sulfur, and accordingly generates no hydrogen sulfide.

The solid electrolyte materials according to Examples 1-1, 2-1, and 3-1 each exhibited favorable discharge characteristics in the battery using NCM as the positive electrode active material. Thus, the solid electrolyte material of the present disclosure can be used together with a positive electrode active material capable of charge and discharge at a potential of 4 V or more. Therefore, the solid electrolyte materials of the present disclosure can enhance the energy density of a battery.

The above tendency holds true for even the case where F, Br, or I is used as the halogen element. These elements have chemical and electronic properties that are quite similar to those of Cl, and accordingly can be substituted for part or the whole of Cl.

As described above, the solid electrolyte material of the present disclosure is substantially free of a rare-earth element and sulfur, has a high ionic conductivity, and is suitable for providing a battery capable of favorable charge and discharge.

### INDUSTRIAL APPLICABILITY

The battery of the present disclosure can be used as, for example, an all-solid-state lithium-ion secondary battery.

What is claimed is:

1. A solid electrolyte material comprising Li, O, and X, wherein
the X is at least one selected from the group consisting of F, Cl, Br, and I, and
the solid electrolyte material satisfies any one of the following (A) to (C):
(A) the solid electrolyte material consists substantially of Li, Si, Al, O, and the X;
(B) the solid electrolyte material consists substantially of Li, Mg, AI, O, and the X; and
(C) the solid electrolyte material comprises Li, Cr, Al, O, and the X, or consists substantially of Li, Cr, O, and the X.

2. The solid electrolyte material according to claim 1, wherein
the solid electrolyte material satisfies the (A), and
the solid electrolyte material is represented by the following composition formula (1): 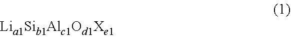
where a1>0, b1>0, c1>0, d1>0, and e1>0 are satisfied.

3. The solid electrolyte material according to claim 2, wherein in the composition formula (1), c1/(a1+c1)>0.4 is satisfied.

4. The solid electrolyte material according to claim 2, wherein in the composition formula (1), c1/(a1+c1)<0.95 is satisfied.

5. The solid electrolyte material according to claim 2, wherein in the composition formula (1), e1/(d1+e1)>0.4 is satisfied.

6. The solid electrolyte material according to claim 2, wherein in the composition formula (1), e1/(d1+e1)<0.95 is satisfied.

7. The solid electrolyte material according to claim 2, wherein in the composition formula (1), b1/c1>0.05 is satisfied.

8. The solid electrolyte material according to claim 2, wherein in the composition formula (1), b1/c1<1.0 is satisfied.

9. The solid electrolyte material according to claim 1, wherein
the solid electrolyte material satisfies the (A),
the solid electrolyte material comprises a 1-1st crystalline phase, and
in an X-ray diffraction pattern of the 1-1st crystalline phase obtained by X-ray diffraction measurement using Cu-Kα radiation,
at least one peak is present within each of ranges of a diffraction angle 2θ from 14° to 16°, from 18° to 19°, from more than 19° to 20°, from 26° to 28°, from more than 28° to 30.5°, and from 47° to 50°, and
at least three peaks are present within a range of the diffraction angle 2θ from more than 30.5° to 33°.

10. The solid electrolyte material according to claim 1, wherein
the solid electrolyte material satisfies the (A),
the solid electrolyte material comprises a 1-2nd crystalline phase, and
in an X-ray diffraction pattern of the 1-2nd crystalline phase obtained by X-ray diffraction measurement using Cu-Kα radiation,
at least one peak is present within each of ranges of a diffraction angle 2θ from 11° to 14°, from 15° to 17°, from more than 23° to 26°, from more than 26° to 28.5°, and from more than 28.5° to 30°, and
at least two peaks are present within each of ranges of the diffraction angle 2θ from 20° to 23° and from 30.5° to 33°.

11. The solid electrolyte material according to claim 1, wherein
the solid electrolyte material satisfies the (B), and
the solid electrolyte material is represented by the following composition formula (2): 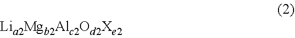
where a2>0, b2>0, c2>0, d2>0, and e2>0 are satisfied.

12. The solid electrolyte material according to claim 11, wherein
in the composition formula (2), c2/(a2+c2)>0.1 is satisfied.

13. The solid electrolyte material according to claim 11, wherein
in the composition formula (2), c2/(a2+c2)<0.95 is satisfied.

14. The solid electrolyte material according to claim 11, wherein
in the composition formula (2), e2/(d2+e2)>0.4 is satisfied.

15. The solid electrolyte material according to claim 11, wherein
in the composition formula (2), e2/(d2+e2)<0.95 is satisfied.

16. The solid electrolyte material according to claim 11, wherein
in the composition formula (2), b2/c2>0.05 is satisfied.

17. The solid electrolyte material according to claim 11, wherein
in the composition formula (2), b2/c2<2 is satisfied.

18. The solid electrolyte material according to claim 1, wherein
the solid electrolyte material satisfies the (B),
the solid electrolyte material comprises a 2-1st crystalline phase, and
in an X-ray diffraction pattern of the 2-1st crystalline phase obtained by X-ray diffraction measurement using Cu-Kα radiation,
at least one peak is present within each of ranges of a diffraction angle 2θ from 28° to 32°, from 33° to 37°, and from 48° to 52°.

19. The solid electrolyte material according to claim 1, wherein
the solid electrolyte material satisfies the (C), and
the solid electrolyte material is represented by the following composition formula (3): 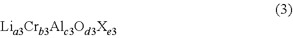
where a3>0, b3>0, c3>0, d3>0, and e3>0 are satisfied.

20. The solid electrolyte material according to claim 19, wherein
in the composition formula (3), b3/(a3+b3)>0.025 is satisfied.

21. The solid electrolyte material according to claim 19, wherein
in the composition formula (3), b3/(a3+b3)<0.95 is satisfied.

22. The solid electrolyte material according to claim 19, wherein
in the composition formula (3), e3/(d3+e3)>0.4 is satisfied.

23. The solid electrolyte material according to claim 19, wherein
in the composition formula (3), e3/(d3+e3)<0.95 is satisfied.

24. The solid electrolyte material according to claim 19, wherein
in the composition formula (3), 0≤c3/b3≤20 is satisfied.

25. The solid electrolyte material according to claim 1 wherein
the solid electrolyte material satisfies the (C),
the solid electrolyte material comprises a 3-1st crystalline phase, and
in an X-ray diffraction pattern of the 3-1st crystalline phase obtained by X-ray diffraction measurement using Cu-Kα radiation,
at least one peak is present within each of ranges of a diffraction angle 2θ from 28° to 32°, from 33° to 37°, and from 48° to 52°.

26. The solid electrolyte material according to claim 1, wherein
the solid electrolyte material satisfies the (C),
the solid electrolyte material comprises a 3-2nd crystalline phase, and
in an X-ray diffraction pattern of the 3-2nd crystalline phase obtained by X-ray diffraction measurement using Cu-Kα radiation,
at least one peak is present within each of ranges of a diffraction angle 2θ from 23° to 27°, from 32° to 35°, from more than 35° to 38°, from 40° to 44°, and from 53° to 57°.

27. The solid electrolyte material according to claim 1, wherein
the X comprises Cl.

28. A battery comprising:
a positive electrode;
a negative electrode; and
an electrolyte layer disposed between the positive electrode and the negative electrode, wherein
at least one selected from the group consisting of the positive electrode, the negative electrode, and the electrolyte layer comprises the solid electrolyte material according to claim 1.
